(19) United States
(12) Patent Application Publication
(10) Pub. No.: US 2013/0196642 A1
(43) Pub. Date: Aug. 1, 2013

(54) COMMUNICATION DEVICE, RECORDING MEDIUM, AND COMMUNICATION METHOD

(71) Applicant: FUJITSU LIMITED, Kawasaki-shi (JP)

(72) Inventors: Kaori ENDO, Yokohama (JP); Shoji HAYAKAWA, Akashi (JP)

(73) Assignee: FUJITSU LIMITED, Kawasaki-shi (JP)

(21) Appl. No.: 13/683,915

(22) Filed: Nov. 21, 2012

(30) Foreign Application Priority Data
Jan. 31, 2012 (JP) 2012-018892

(51) Int. Cl. H04W 4/00

(52) U.S. Cl. CPC H04W 4/001
USPC 455/418

(57) ABSTRACT

A mobile phone, into which a voice call function is embedded, includes a processor that controls the entire mobile phone, and a function DB that stores control content of respective voice processing which is to be performed on a call voice, in association with each call category. In addition, the processor estimates a call category type on the basis of an amount of transmitting voice of current communication content, and reads the control content of the respective voice processing corresponding to the call category type from the function DB. Furthermore, the processor performs the respective voice processing on the call voice being communicated, on the basis of the read control content of the respective voice processing.

### CROSS-REFERENCE TO RELATED APPLICATION

This application is based upon and claims the benefit of priority of the prior Japanese Patent Application No. 2012-018892, filed on Jan. 31, 2012, the entire contents of which are incorporated herein by reference.

### FIELD

The embodiments discussed herein are related to a communication device, a recording medium, and a communication method.

### BACKGROUND

A communication device, such as a mobile phone used for a voice call, has voice processing functions, such as a voice rate change function of changing a voice rate of a speaker, a noise canceller function of cancelling ambient noise of a call voice, an echo canceller function of cancelling an echo of a call voice, and the like. ON/OFF of the voice processing functions is uniformly set without regard to current communication content.

However, in the communication device having the voice processing functions, for example, when an information service, such as “177” weather forecast, is received, the voice processing function, such as the echo canceller function, is not needed. Therefore, in the communication device, since the setting content of the voice processing functions is uniformly set without regard to current communication content, unnecessary voice processing functions are executed.

Further, in the case of an ordinary call, it may be conceivable to execute the voice processing function so as to make a call voice of the other party heard comfortably. However, in the case of a high-emergency call, it is important to certainly hear a call voice without regard to whether or not the call voice is comfortably heard. Therefore, in the high-emergency call, it may be said that the voice processing function of making the call voice heard comfortably is unnecessary processing.

Further, in a recent communication device, there is known a technology that disables the execution of the unnecessary voice processing function, for example, by setting ON or OFF of the voice processing function to each party registered in a phone book. In the case of this technology, the voice processing function set to each party is one type.

Japanese Laid-open Patent Publication No. 2011-87196

However, a communication device sets ON/OFF of a voice processing function to each party registered in a phone book, and when the voice processing function is multiple, the communication sets each voice processing function all the way. Therefore, workload for the setting is heavy.

Furthermore, in the communication device, ON/OFF of the voice processing function is set to each party who is registered in the phone book, but it is difficult for the setting content of the voice processing function to be registered with respect to parties who are not registered in the phone book. Therefore, each voice processing function suitable for current communication content is not performed to a call voice.

### SUMMARY

According to an aspect of the embodiments, a communication device includes a memory; a processor coupled to the memory; and a storage that stores control content of respective processing which is to be performed on a call voice being communicated, in association with each call category of the communication, wherein the processor executes a process including: determining a call category on the basis of an amount of transmitting voice being communicated; reading the control content of the respective processing corresponding to the call category from the storage; and performing the respective processing to the call voice being communicated, on the basis of the read control content of the respective processing.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a mobile phone of an embodiment;

FIG. 2 is an explanatory diagram illustrating an example of a function DB;

FIG. 3 is an explanatory diagram illustrating an example of a phone number DB;

FIG. 4 is an explanatory diagram illustrating an example of a block representation of a processing function in a processor;

FIG. 5 is a flowchart illustrating an example of the processing operation of the processor of the mobile phone in relation to parameter setting processing;

FIG. 6 is a flowchart illustrating an example of the processing operation of the processor of the mobile phone in relation to phone number classification processing;

FIG. 7 is a flowchart illustrating an example of the processing operation of the processor of the mobile phone in relation to call category estimation processing; and

FIG. 8 is an explanatory diagram illustrating a computer that executes a communication program.

### DESCRIPTION OF EMBODIMENTS

Preferred embodiments of the present invention will be explained with reference to accompanying drawings. Note that, the disclosed technology is not limited by the embodiments. Further, the following embodiments may be appropriately combined within a scope that causes no contradiction.

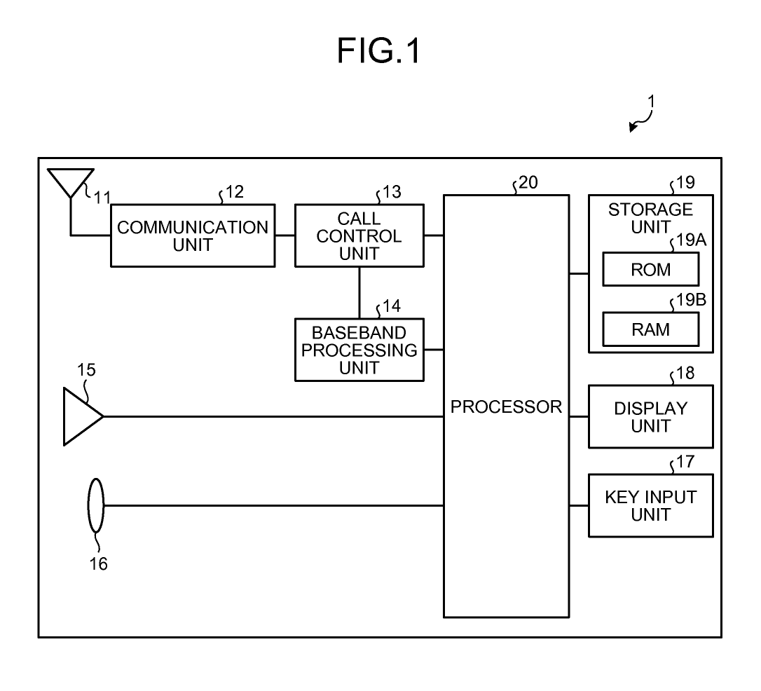

FIG. 1 is a block diagram illustrating an example of a mobile phone 1 of an embodiment. The mobile phone 1 illustrated in FIG. 1 includes an antenna 11, a communication unit 12, a call control unit 13, a baseband processing unit 14, a speaker 15, a microphone 16, a key input unit 17, a display unit 18, a storage unit 19, and a processor 20. The communication unit 12 has a wireless communication function of transmitting and receiving wireless radio waves through the antenna 11. The call control unit 13 controls a call connection of the wireless communication function. The baseband processing unit 14 performs baseband processing on transmitted and received data of the wireless communication function.

The speaker 15 converts an electrical signal into a voice signal and outputs the voice signal. The microphone 16 converts a picked-up voice signal into an electrical signal. The key input unit 17 is an operation unit that inputs a variety of information, for example, a command and the like.

The display unit 18 displays a variety of information on a screen. The storage unit 19 includes a Read Only Memory (ROM) 19A and a Random Access Memory (RAM) 19B. The ROM 19A stores a variety of information, for example, a variety of programs such as a communication program, which is to be described later. Note that, the ROM 19A may be a rewritable EPROM. The RAM 19B has an area that stores a variety of information. The RAM 19B stores, for example, a function database (hereinafter, simply referred to as DB) 191 and a phone number DB 192.

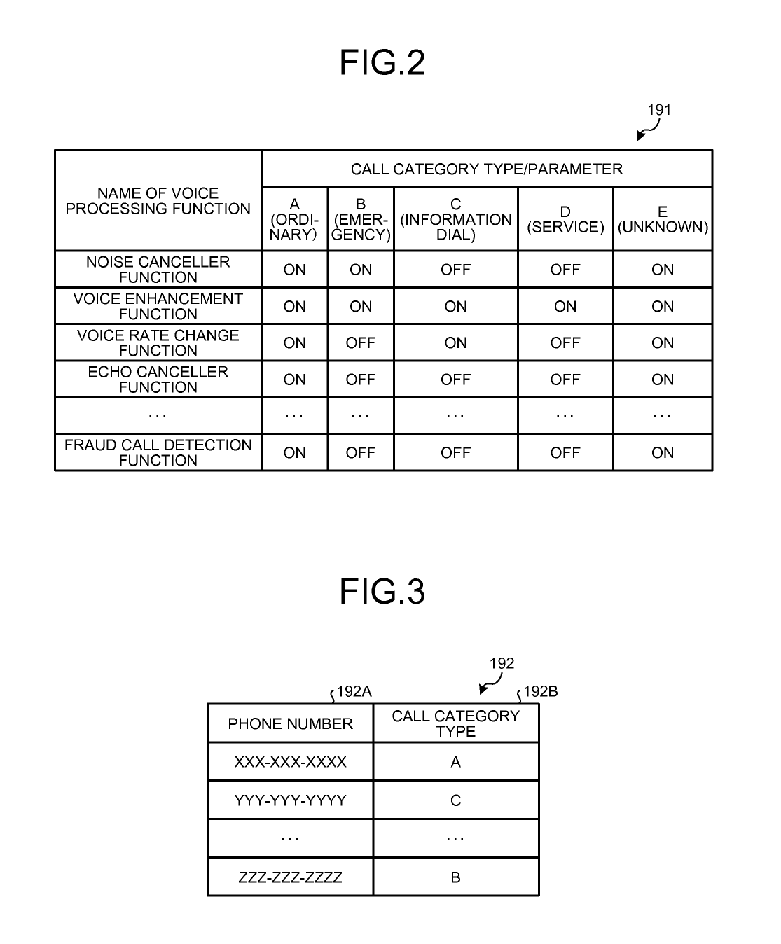

FIG. 2 is an explanatory diagram illustrating an example of the function DB 191. The function DB 191 illustrated in FIG. 2 manages parameters of each voice processing function with respect to each call category type. The call category type is to identify the call category. Note that, in the call category, for example, there are types such as an ordinary call, an emergency call, an information dial, a service call, and an unknown call. The ordinary call is type A, the emergency call such as report to the police is type B, the information dial such as a weather forecast is type C, the service call using a tone is type D, and the case where the call category is unknown is type E.

Further, examples of the voice processing function include a noise canceller function, a voice enhancement function, a voice rate change function, an echo canceller function, and a fraud call detection function, and the like. The noise canceller function is to suppress ambient environmental noise mixed in the transmission of a call voice. The voice enhancement function is to enable the call voice to be easily heard even under ambient environmental noise by enhancing the level of the voice component of the call voice. The voice rate change function is to adjust the voice rate of the call voice. The echo canceller function is to suppress an echo caused when the voice output from the speaker 15 is entered into the microphone 16. The fraud call detection function is to analyze a user's call voice and detect a fraud call by using voice features represented by a user's stress or the like.

In the example of the parameters of the voice processing function illustrated in FIG. 2, when the call category is type A (ordinary call), all of the noise canceller function, the voice enhancement function, the voice rate change function, the echo canceller function, and the fraud call detection function are ON. Further, when the call category is type B (emergency call), the noise canceller function and the voice enhancement function are ON, and the voice rate change function, the echo canceller function, and the fraud call detection function are OFF.

Further, when the call category is type C (information dial), the noise canceller function, the echo canceller function, and the fraud call detection function are OFF, and the voice enhancement function and the voice rate change function are ON. Further, when the call category is type D (service call), the voice enhancement function is ON, and the noise canceller function, the voice rate change function, the echo canceller function, and the fraud call detection function are OFF. Further, when the call category is type E (unknown), all of the noise canceller function, the voice enhancement function, the voice rate change function, the echo canceller function, and the fraud call detection function are ON.

FIG. 3 is an explanatory diagram illustrating an example of the phone number DB 192. The phone number DB 192 illustrated in FIG. 3 stores a phone number 192A and a call category type 192B in association with each other. The phone number 192A is a phone number of the other party related to a call voice. For example, when the phone number 192A is “XXX-XXX-XXXX”, the call category type 192B is “A”. That is, the phone number DB 192 manages the call category type 192B with respect to each phone number 192A.

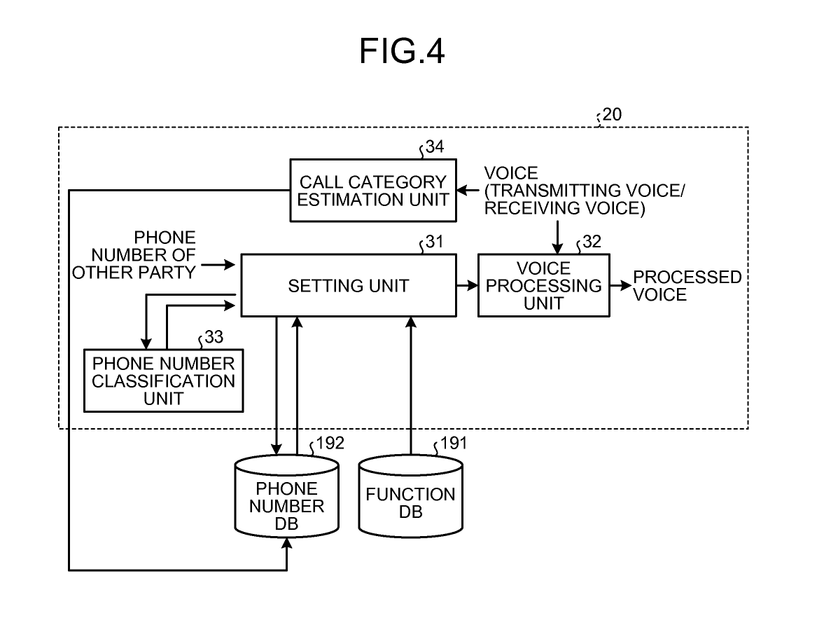

FIG. 4 is an illustration diagram illustrating an example of the block representation of the processing function in the processor 20. The processor 20 illustrated in FIG. 4 executes a setting unit 31, a voice processing unit 32, a phone number classification unit 33, and a call category estimation unit 34 as processing functions. For example, when a phone number of the other party is detected in the event of an incoming call or an outgoing call, the setting unit 31 determines whether or not there is the corresponding phone number in the phone number DB 192. In addition, when there is the corresponding phone number, the setting unit 31 acquires the call category type, associated with the corresponding phone number, from the phone number DB 192. Furthermore, the setting unit 31 reads a set of parameters (control content) of the respective voice processing functions, associated with the call category types, from the function DB 191. The setting unit 31 sets the read parameters of the respective voice processing functions to the voice processing unit 32. The voice processing unit 32 turns ON/OFF the respective voice processing functions, based on the set parameters of the respective voice processing functions, and controls the call voice by using the respective voice processing functions.

Further, the phone number classification unit 33 classifies the call category type from the feature of the phone number of the other party. When the phone number of the other party is, for example, either of police “110”, fire and emergency “119”, marine accident “118”, and disaster message “171”, the phone number classification unit 33 determines that the call category is the emergency call, that is, “type B”. Further, when the phone number of the other party is, for example, weather forecast “177”, the phone number classification unit 33 determines that the call category is the information dial, that is, “type C”.

Further, for example, when the phone number of the other party is triple digits and is neither of “110”, “119”, “118”, “171”, and “177”, and the phone number of the other party is “0120”, the phone number classification unit 33 determines that the call category is the service, that is, “type D”.

Further, the call category estimation unit 34, for example, determines the call category type on the basis of an amount of transmitting voice of the other party during communication. The call category estimation unit 34, for example, determines whether or not a ratio of a voice frame to a communication frame from a communication start until now, with being in communication, is less than a first threshold value TH1. Further, the call category estimation unit 34 determines whether or not a ratio of a tone frame to a communication frame from a communication start until now, with being in communication, is less than a second threshold value TH2. When the ratio of the voice frame is less than the first threshold value TH1, the call category estimation unit 34 estimates the call category as the information dial, that is, type C.

Further, when the ratio of the voice frame is not less than the first threshold value TH1 and the ratio of the tone frame is not less than the second threshold value TH2, the call category estimation unit 34 estimates the call category as the service call, that is, type D. Further, when the ratio of the voice frame is not less than the first threshold value TH1 and the ratio of the tone frame is less than the second threshold value TH2, the call category estimation unit 34 estimates the call category as the ordinary call, that is, type A.

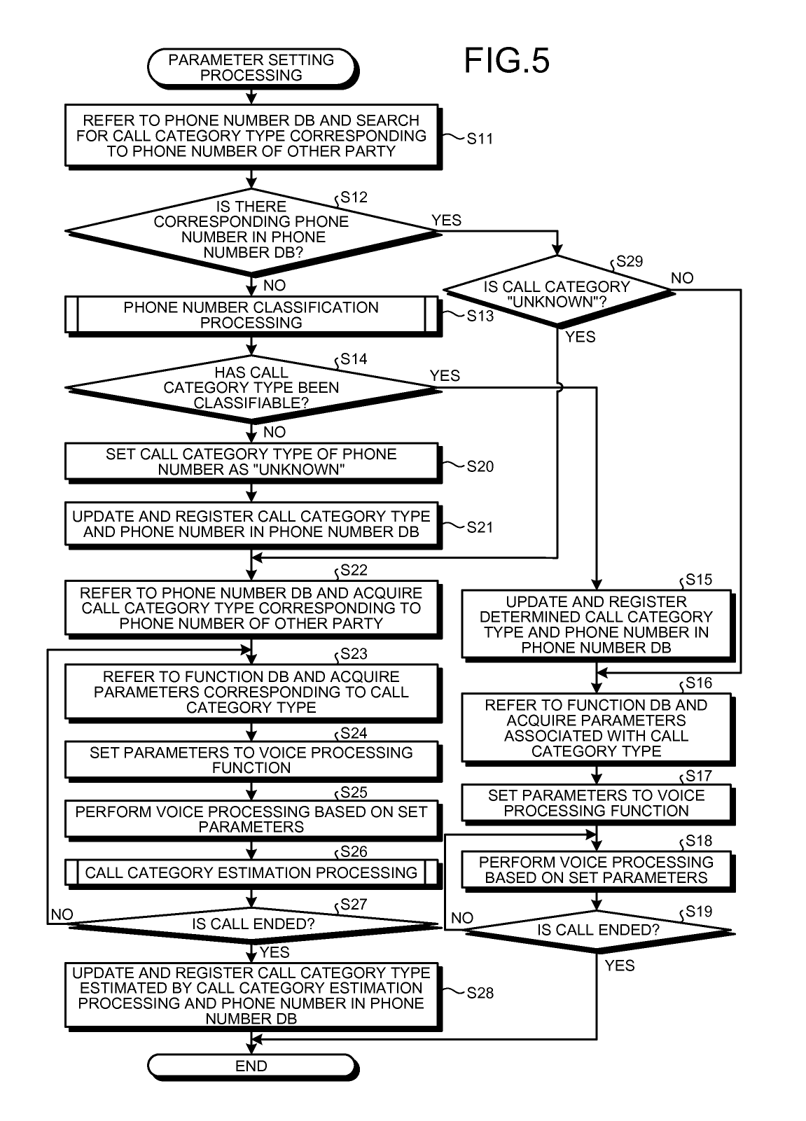

Next, the operation of the mobile phone 1 of the embodiment will be described. FIG. 5 is a flowchart illustrating an example of the processing operation of the processor 20 of the mobile phone 1 in relation to parameter setting processing. The parameter setting processing illustrated in FIG. 5 is processing that specifies the call category from the communication content being currently communicated, collectively sets the parameters of the respective voice processing functions, associated with the specified communication category, to the voice processing unit 32, and performs the respective voice processing on the call voice. The parameter setting processing is performed when there is an outgoing call or an incoming call in the mobile phone 1.

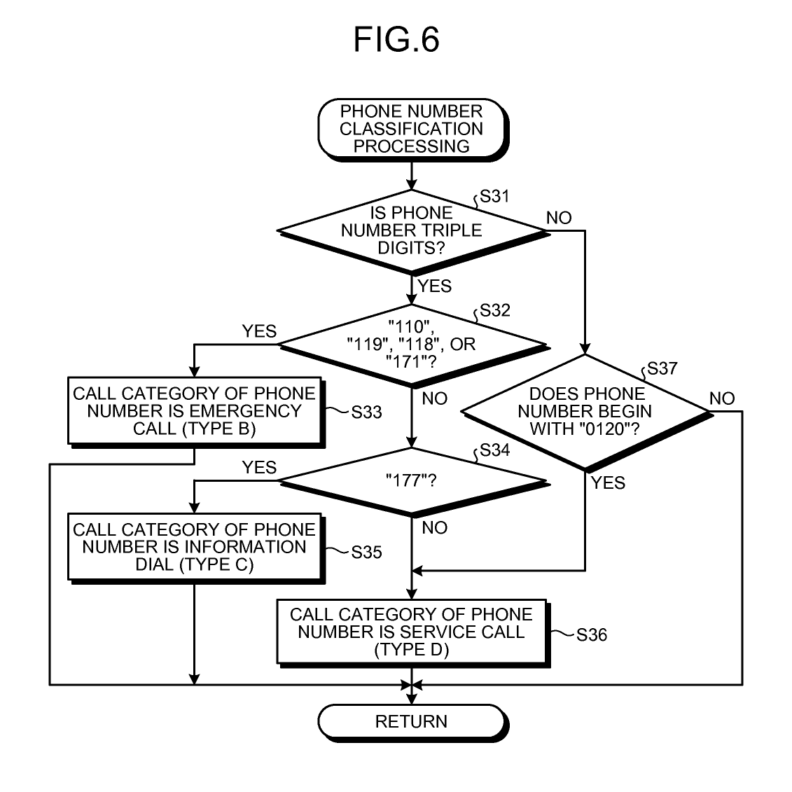

In FIG. 5, the setting unit 31 in the processor 20 refers to the phone number DB 192 and searches the phone number of the other party in the phone number DB 192 (step S11). The setting unit 31 determines whether or not there is the corresponding phone number in the phone number DB 192 (step S12). When there is no corresponding phone number in the phone number DB 192 (No in step S12), the phone number classification unit 33 in the processor 20 performs phone number classification processing, which is illustrated in FIG. 6 to be described later, to determine the call category from the feature of the phone number of the other party (step S13). The phone number classification unit 33 determines whether or not the call category type associated with the phone number of the other party has been classifiable by the phone number classification processing (step S14).

When the call category type of the phone number has been classifiable (Yes in step S14), the phone number classification unit 33 updates and registers the classifiable call category type and the phone number of the other party in the phone number DB 192 (step S15). The setting unit 31 refers to the function DB 191 and acquires parameters associated with the call category type in the function DB 191 (step S16), and sets the parameters to the respective voice processing functions of the voice processing unit 32 (step S17). The voice processing unit 32 in the processor 20 performs voice processing on the call voice, based on the parameters of the respective voice processing functions (step S18). The processor 20 determines whether or not the call is ended (step S19).

When the call is ended (Yes in step S19), the processor 20 ends the processing operation illustrated in FIG. 5. Further, when the call is not ended (No in step S19), the processor 20 proceeds to step S18 so as to perform the voice processing based on the set parameters.

Further, when the call category type of the phone number has not been classifiable (No in step S14), the phone number classification unit 33 sets the call category type of the phone number of the other party as “unknown”, that is, type D (step S20). Furthermore, the setting unit 31 updates and registers the call category type and the phone number of the other party in the phone number DB 192 (step S21). The setting unit 31 refers to the phone number DB 192 and acquires the call category type associated with the phone number of the other party in the phone number DB 192 (step S22).

The setting unit 31 refers to the function DB 191 and acquires parameters associated with the call category type in the function DB 191 (step S23), and sets the parameters to the respective voice processing functions of the voice processing unit 32 (step S24). The voice processing unit 32 in the processor 20 performs voice processing on the call voice, based on the parameters of the respective voice processing functions (step S25).

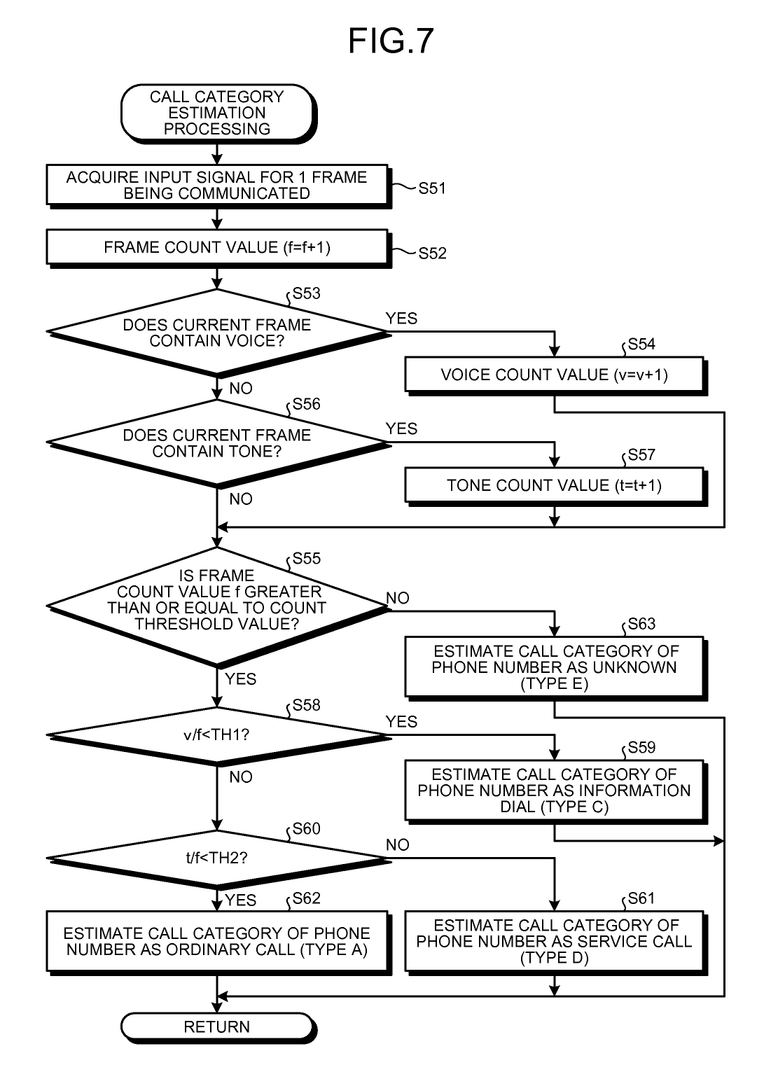

The call category estimation unit 34 performs call category estimation processing, which is illustrated in FIG. 7 to be described later, to estimate the call category type in real time from the current communication content, while performing the voice processing based on the set parameters (step S26). After performing the call category estimation processing, the call category estimation unit 34 determines whether or not the call is ended (step S27). When the call is ended (Yes in step S27), the call category estimation unit 34 updates and registers the call category type estimated in the call category estimation unit 34 and the phone number of the other party in the phone number DB 192 in association with each other (step S28), and ends the processing operation illustrated in FIG. 5.

Further, when the call is not ended (No in step S27), the setting unit 31 proceeds to step S23 so as to acquire parameters in the call category type estimated in the call category estimation unit 34. As a result, it is possible to set the parameters of the voice processing functions, which are reflected based on the call category of the current communication content.

Further, when there is the corresponding phone number within the phone number DB 192 (Yes in step S12), the setting unit 31 determines whether or not the call category of the corresponding phone number is “unknown” (step S29). When the call category of the corresponding phone number is “unknown” (Yes in step S29), the setting unit 31 proceeds to step S22 so as to acquire the call category type associated with the phone number of the other party with reference to the phone number DB 192.

Further, when the call category of the corresponding phone number is not “unknown” (No in step S29), the setting unit 31 proceeds to step S16 so as to acquire the parameters associated with the call category type.

In the parameter setting processing illustrated in FIG. 5, when there is the corresponding phone number within the phone number DB 192 and the call category is not “unknown”, the parameters of the respective voice processing functions associated with the call category type of the corresponding phone number are read. The read parameters of the respective voice processing functions are set to the respective voice processing functions in the voice processing unit 32. As a result, the voice processing of the respective voice processing functions associated with the call category type can be performed on the call voice.

Further, in the parameter setting processing, when there is no corresponding phone number within the phone number DB 192 and the phone number classification unit 33 could specify the call category type from the feature of the phone number, the parameters associated with the specified call category type are read. The read parameters of the respective voice processing functions are set to the respective voice processing functions in the voice processing unit 32. As a result, even when not registered in the phone number DB 192, the voice processing of the respective voice processing functions associated with the call category type can be performed on the call voice.

In the parameter setting processing, when there is no corresponding phone number within the phone number DB 192 and the call category type cannot be specified from the feature of the phone number, the communication category type is estimated from an amount of voice of communication content, and the parameters associated with the estimated call category type are read. The read parameters of the respective voice processing functions are set to the respective voice processing functions in the voice processing unit 32. As a result, even when the call category cannot be specified from the feature of the phone number, the voice processing of the respective voice processing functions associated with the call category type can be performed on the call voice.

In the parameter setting processing, when there is the corresponding phone number in the phone number DB 192 and the call category type is “unknown”, the communication category type is estimated on the basis of an amount of transmitting voice of communication content, and the parameters associated with the estimated call category type are read. The read parameters of the respective voice processing functions are set to the respective voice processing functions in the voice processing unit 32. As a result, even when the call category is “unknown”, the voice processing of the respective voice processing functions associated with the call category type can be performed on the call voice.

FIG. 6 is a flowchart illustrating the processing operation in the processor 20 of the mobile phone 1 in relation to phone number classification processing. The phone number classification processing illustrated in FIG. 6 is processing that specifies the call category type on the basis of the feature of the phone number of the other party, even when the phone number is not registered in the phone number DB 192.

In FIG. 6, the phone number classification unit 33 in the processor 20 determines whether or not the phone number of the other party is, for example, triple digits (step S31). When the phone number of the other party is, for example, triple digits (Yes in step S31), the phone number classification unit 33 determines whether or not the phone number is either of “110”, “119”, “118” and “171” (step S32).

When the phone number of the other party is either of “110”, “119”, “118”, and “171” (Yes in step S32), the phone number classification unit 33 classifies the call category of the phone number as the emergency call, that is, “type B” (step S33), and ends the processing operation illustrated in FIG. 6.

Further, when the phone number of the other party is neither of “110”, “119”, “118” and “171” (No in step S32), the phone number classification unit 33 determines whether or not the phone number is “177” (step S34). When the phone number is “177” (Yes in step S34), the phone number classification unit 33 classifies the call category of the phone number being the weather forecast as the information dial, that is, “type C” (step S35), and ends the processing operation illustrated in FIG. 6.

Further, when the phone number is not “177” (No in step S34), the phone number classification unit 33 classifies the call category of the phone number as the service call, that is, “type D” (step S36), and ends the processing operation illustrated in FIG. 6.

Further, when the phone number is not, for example, triple digits (No in step S31), the phone number classification unit 33 determines whether or not the phone number begins with, for example, “0120” (step S37). When the phone number begins with, for example, “0120” (Yes in step S37), the phone number classification unit 33 proceeds to step S36 so as to classify the call category of the phone number as the service call, that is, “type D”.

Further, when the phone number does not begin with, for example, “0120” (No in step S37), the phone number classification unit 33 ends the processing operation illustrated in FIG. 6.

In the phone number classification processing illustrated in FIG. 6, when the phone number is “110”, “119”, “118”, or “171”, the call category is classified as the emergency call, that is, “type B”. Further, in the phone number classification processing, when the phone number is “177”, the call category is classified as the information dial, that is, “type C”. Further, in the phone number classification processing, when the phone number begins with, for example, “0120”, the call category is classified as the information dial, that is, “type D”. That is, in the phone number classification processing, the call category type can be classified from the feature of the phone number.

FIG. 7 is a flowchart illustrating an example of the processing operation of the processor 20 of the mobile phone 1 in relation to call category estimation processing. The call category estimation processing illustrated in FIG. 7 is processing that estimates the call category from an amount of transmitting voice of communication content being currently communicated.

In FIG. 7, the call category estimation unit 34 in the processor 20 acquires an input signal for 1 frame of a voice side from the communication content being currently communicated (step S51). Note that, the voice side is a transmission side of the mobile phone 1. When the input signal for the 1 frame is acquired, the call category estimation unit 34 increments a frame count value f by +1 (step S52). The call category estimation unit 34 determines whether or not a current frame contains a voice (step S53).

When the current frame contains the voice (Yes in step S53), the call category estimation unit 34 determines the current frame as a voice frame and increments a voice count value v by +1 (step S54). The call category estimation unit 34 determines whether or not the current frame count value f is greater than or equal to a count threshold value (step S55). Further, the count threshold value is a minimum frame count value that enables the call category estimation unit 34 to estimate the call category.

Further, when the current frame contains no voice (No in step S53), the call category estimation unit 34 determines whether or not the current frame contains a tone (step S56). When the current frame contains the tone (Yes in step S56), the call category estimation unit 34 increments a tone count value t by +1 (step S57), and proceeds to step S55 so as to determine whether or not the frame count value f is greater than or equal to the count threshold value. Note that, when the current frame contains no tone (No in step S56), the call category estimation unit 34 proceeds to step S55.

When the current frame count value f is greater than or equal to the count threshold value (Yes in step S55), the call category estimation unit 34 determines whether or not a ratio (v/f) of the voice count value v to the frame count value f is less than a first threshold value TH1 (step S58). Further, the first threshold value TH1 is a threshold value determining a state in which a calling party remains silent.

When the ratio of the voice count value v is less than the first threshold value TH1 (Yes in step S58), the call category estimation unit 34 estimates the call category of the phone number as the information dial, that is, “type C” (step S59), and ends the processing operation illustrated in FIG. 7.

Further, when the ratio of the voice count value v is not less than the first threshold value TH1 (No in step S58), the call category estimation unit 34 determines whether or not a ratio (t/f) of the tone count value t to the frame count value f is less than a second threshold value TH2 (step S60). Note that, the second threshold value TH2 is a threshold value determining, for example, whether or not a push button is pressed.

When the ratio of the tone count value is not less than the second threshold value TH2 (No in step S60), the call category estimation unit 34 estimates the call category of the phone number as the service call, that is, “type D” (step S61), and ends the processing operation illustrated in FIG. 7.

Further, when the ratio of the tone count value t is less than the second threshold value TH2 (Yes in step S60), the call category estimation unit 34 estimates the call category of the phone number as the ordinary call, that is, “type A” (step S62), and ends the processing operation illustrated in FIG. 7.

Further, when the current frame count value f is not greater than or equal to the count threshold value (No in step S55), the call category estimation unit 34 estimates the call category of the phone number as unknown, that is, “type E” (step S63), and ends the processing operation illustrated in FIG. 7.

In the call category estimation processing illustrated in FIG. 7, when the amount of voice of the communication content being currently communicated, that is, the ratio of the voice, is less than the first threshold value TH1, the call category is estimated as the information dial, that is, “type C”, in real time.

In the call category estimation processing, when the ratio of the voice is not less than the first threshold value TH1 and the ratio of the tone is not less than the second threshold value TH2, the call category is estimated as the service call, that is, “type D”, in real time.

Further, in the call category estimation processing, when the ratio of the voice is not less than the first threshold value TH1 and the ratio of the tone is less than the second threshold value TH2, the call category is estimated as the ordinary call, that is, “type A”, in real time.

That is, in the call category estimation processing, the call category type can be estimated in real time on the basis of the amount of transmitting voice being currently communicated.

In the embodiment, since only necessary processing among a plurality of voice processing functions is performed according to the phone number of the other party, unnecessary processing can be reduced.

Further, in the embodiment, since a plurality of voice processing functions are adjusted according to the phone number of the other party, appropriate processing can be performed as compared to the case where processing is uniformly performed.

In the embodiment, appropriate voice processing can be performed on the call voice of the phone number by the optimum parameters, which are associated with the phone number, with reference to the function DB 191 in which the call category type of the phone number and the parameters of the respective voice processing functions are stored in association with each other.

In the embodiment, even when there is no corresponding phone number in the phone number DB 192, appropriate voice processing can be performed on the call voice because the call category is specified from the feature of the phone number itself

In the embodiment, even when the call category cannot be specified in the phone number classification unit 33, appropriate voice processing can be performed on the call voice of the phone number because the call category estimation unit 34 estimates the call category in real time, based on the amount of transmitting voice of the current communication content.

Note that, although the mobile phone 1 has been taken as an example of the communication device, the embodiment may also be applied to a terminal having a communication function realizing a voice communication, such as a smartphone, a computer, or a fixed IP phone. Further, in the embodiment, although the parameters of the voice processing functions in the processor 20 have been set, a voice processing circuit, which is separate from the processor 20, may be embedded into a mobile phone, and the setting of parameters of the respective voice processing functions of the voice processing circuit may be modified.

Further, although the noise canceller function, the voice enhancement function, the voice rate change function, the echo canceller function, and the fraud call detection function are taken as an example of the voice processing function, the embodiment is not limited to these functions and may also be applied to other functions, such as a sound field adjustment function.

Further, in the embodiment, although ON/OFF of the functions has been taken as the parameters of the voice processing function, specific values of the functions may also be set.

Further, in the embodiment, when the call category type could not be specified as a type other than “unknown” in the phone number DB 192 and the phone number classification unit 33, the call category estimation processing of the call category estimation unit 34 has not been performed. However, even when the call category type could be specified as a type other than “unknown” in the phone number DB 192 and the phone number classification unit 33, the call category estimation unit 34 may perform the call category classification processing. In this case, when the call category type reflected on the current communication content is estimated in real time, the processor reads the parameters associated with the call category type in each case. The read parameters of the respective voice processing functions are set to the respective voice processing functions of the voice processing unit 32. As a result, the voice processing of the respective voice processing functions, reflected on the current communication content, can be performed on the call voice.

Further, the respective components of the illustrated respective units need not be necessarily configured physically as illustrated. That is, the specific forms of distribution/integration of the respective units are not limited to those illustrated in the drawings, and all or part thereof may be configured by physical or functional distribution/integration in arbitrary units according to various loads or usage conditions.

Furthermore, all or an arbitrary part of a variety of processing functions performed by the respective apparatuses or devices may be executed on a Central Processing Unit (CPU) (or a microcomputer such as a Micro Processing Unit (MPU), a Micro Controller Unit (MCU), or the like). Moreover, it is apparent that all or an arbitrary part of a variety of processing functions may be executed on a program analyzed and executed in a CPU (or a microcomputer such as an MPU, an MCU, or the like), or may be executed on hardware by a wired logic.

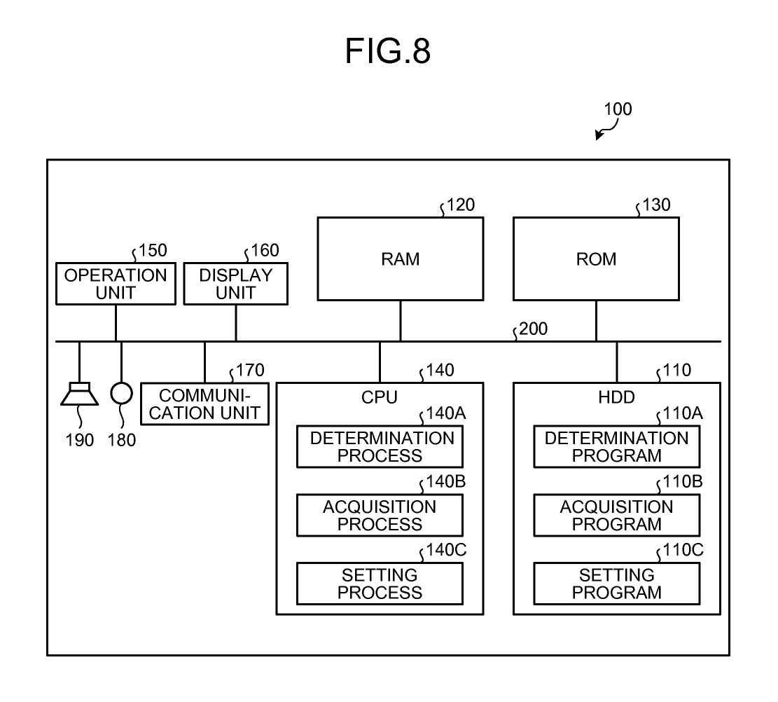

A variety of processing described in the embodiments may be realized by executing a prepared program on a computer. Therefore, hereinafter, an example of a computer executing a program having the same function as the embodiment will be described. FIG. 8 is an explanatory diagram illustrating a computer that executes a communication program.

The computer 100, which executes the communication program illustrated in FIG. 8, includes a Hard Disk Drive (HDD) 110, a RAM 120, a ROM 130, and a CPU 140. In addition, the computer 100 includes an operation unit 150, a display unit 160, a communication unit 170, a microphone 180, and a speaker 190. In the computer 100, the HDD 110, the RAM 120, the ROM 130, the CPU 140, the operation unit 150, the display unit 160, the communication unit 170, the microphone 180, and the speaker 190 are connected through a bus 200.

The HDD 110 prestores a communication program exhibiting the same function as the embodiment. Note that, instead of the HDD 110, the communication program may be recorded in the ROM 130 or a computer-readable recording medium as a drive that is not illustrated. Further, examples of the recording medium may include a portable recording medium, such as a CD-ROM, a DVD disk, or a USB memory, and a semiconductor memory, such as a flash memory. As illustrated in FIG. 8, the communication program includes a determination program 110A, an acquisition program 110B, and a setting program 110C. Note that, the programs 110A, 110B and 110C may be appropriately integrated or distributed.

The CPU 140 reads these programs 110A, 110B and 110C in the HDD 110. As illustrated in FIG. 8, the CPU 140 reads the respective programs 110A, 110B and 110C, and functions as a determination process 140A, an acquisition process 140B, and a setting process 140C. Further, the RAM 120 stores control content of respective processing, which is to be performed on the call voice, in each call category of communication.

The CPU 140 determines the call category in real time on the basis of the amount of transmitting voice being communicated. The CPU 140 reads the control content of respective processing, associated with the determined call category, in the RAM 120. Furthermore, the CPU 140 performs respective processing on the call voice being communicated, based on the read control content of respective processing. As a result, the CPU 140 can perform respective processing suitable for the current communication content with respect to the call voice.

In the disclosed embodiment, each processing suitable for current communication content can be performed on the call voice.

All examples and conditional language recited herein are intended for pedagogical purposes of aiding the reader in understanding the invention and the concepts contributed by the inventors to further the art, and are not to be construed as limitations to such specifically recited examples and conditions, nor does the organization of such examples in the specification relate to a showing of the superiority and inferiority of the invention. Although the embodiment of the present invention has been described in detail, it should be understood that the various changes, substitutions, and alterations could be made hereto without departing from the spirit and scope of the invention.

What is claimed is:

1. A communication device including:
a memory;
a processor coupled to the memory; and
a storage that stores control content of respective processing which is to be performed on a call voice being communicated, in association with each call category of the communication,
wherein the processor executes a process comprising:
determining a call category on the basis of an amount of transmitting voice being communicated;
reading the control content of the respective processing corresponding to the call category from the storage; and
performing the respective processing on the call voice being communicated, on the basis of the read control content of the respective processing.

2. The communication device according to claim 1, wherein the process further comprises:
determining a call category on the basis of a feature of a phone number of a communication destination;
reading the control content of the respective processing corresponding to the call category from the storage; and
performing the respective processing on the call voice being communicated.

3. A computer-readable recording medium having stored therein a communication program that causes a computer to execute a process comprising:
determining a call category on the basis of an amount of transmitting voice being communicated; and
performing respective processing corresponding to the call category on a call voice being communicated, on the basis of control content of the respective processing to be performed on the call voice.

4. A communication method that causes a communication device to perform a process comprising:
determining a call category on the basis of an amount of transmitting voice being communicated; and
performing respective processing corresponding to the call category on a call voice being communicated, on the basis of control content of the respective processing to be performed on the call voice.
